(19) United States
(12) Patent Application Publication
(10) Pub. No.: US 2013/0256155 A1
(43) Pub. Date: Oct. 3, 2013

(54) ELECTRODE FOR BIOSENSOR FOR LPS DETECTION, A METHOD FOR PRODUCING IT AND A METHOD FOR REGENERATING IT

(71) Applicant: RESEARCH & BUSINESS FOUNDATION SUNGKYUNKWAN UNIVERSITY, Suwon-si (KR)

(72) Inventors: Young Kwan Lee, Seoul (KR); Mi Suk Cho, Suwon-si (KR); Li Min Chun, Seoul (KR)

(21) Appl. No.: 13/737,669

(22) Filed: Jan. 9, 2013

(30) Foreign Application Priority Data
Jan. 9, 2012 (KR) 10-2012-0002523

(51) Int. Cl. G01N 27/327

(52) U.S. Cl. CPC G01N 27/3276
USPC 205/782; 427/2.13; 204/403.01

(57) ABSTRACT

A method of forming a biosensor electrode for lipopolysaccharide (LPS) detection includes providing a metal electrode, forming a metal electrode/3-mercaptopropionic acid (MPA) by depositing MPA on the metal electrode, forming a metal electrode/MPA/n-hydroxy-succinimide (NHS) by ester-bonding NHS and the MPA on the metal electrode/MPA, forming a metal electrode/MPA/nitrilotriacetic acid (NTA) by amide-bonding NTA-C₄—NH₂ and the MPA of the metal electrode/MPA/NHS, and forming a metal electrode/MPA/NTA/Cu by coordinate-bonding Cu²⁺ and the NTA of the metal electrode/MPA/NTA.

### CROSS-REFERENCE TO RELATED APPLICATION

This application claims the benefit under 35 U.S.C. §119(a) of Korean Patent Application No. 10-2012-0002523, filed on Jan. 9, 2012, in the Korean Intellectual Property Office, the entire disclosure of which is incorporated herein by reference for all purposes.

### BACKGROUND

1. Field of the Invention

The present invention relates to a biosensor electrode for detection of lipopolysaccharides (LPSs) which includes a nitrilotriacetic acid (NTA)-Cu complex modified gold electrode, and a method of fabricating the same for a competitive electrochemical analysis.

Particularly, a gold electrode having a self-assembled monolayer (SAM) of 3-mercaptopropionic acid (MPA) is treated with NTA-C₄—NH₂, and then chelated with NTA using copper ions. The LPS is coordinated with a free region of an NTA-Cu complex. Performance of the biosensor electrode for LPS detection according to the present invention is evaluated by electrochemical impedance spectroscopy.

2. Discussion of Related Art

Lipopolysaccharides (LPSs) are referred to as endotoxins, which are main components of outer membranes of Gram-negative bacteria. An LPS consists of three distinct portions, that is, a lipid A, a core oligosaccharide, and an O-specific antigen (Raetz, 1990; Plotz et al., 2000; Heras et al., 2010). LPS molecules are non-toxic with a bacterial outer membrane, but become toxic after being separated therefrom. In addition, when an immune cell is exposed to the lipid A, an inflammatory response is induced (Hoess et al., 1993; Amersfoort et al., 2003; Ding et al., 2007). Therefore, a sensitive, easy, and fast method of detecting an LPS is required.

Generally, LPS detection by an electrochemical sensor is performed using two closely related elements. One is a biological recognition element (an enzyme, antibody, receptor, micro-organism, or nucleic acid), and the other is a transducer (electrochemical, mass, or optical) (Sassolas et al., 2009). Recently, an electrochemical biosensor and electrochemical transduction based on a specific antibody-antigen interaction are being developed and applied to detect the presence and concentration of LPSs. Priano et al. developed a competitive analysis method using current measurement to detect an LPS in a biological mixture using a recombinant endotoxin neutralizing protein (ENP) as a recognition element (Priano and 2005; Priano et al., 2007). In addition, Chang et al. developed a method based on an LPS-binding peptide which is synthesized from different areas of a human bacterial protein (Chang et al., 1997). Moreover, a new electrochemical technology for LPS detection based on a combination of ferrocenylboronic acid derivatives and an enzyme-modified electrode has been reported by Kato et al., 2007. Further, an endothelial cell monolayer immobilized on a fibronectin/polystyrene/thiol/gold electrode was fabricated for LPS detection using impedance spectroscopy (Bouafsoun et al., 2008). These sensors are very effective in detecting a low concentration of an LPS due to high selectivity thereof. However, in most cases, labeling of the endotoxin generated by microorganisms as a recognition agent is required (Triantafilou et al., 2000; Haas et al., 2000). In addition, this labeling process and the development of the recognition agent are expensive and time-consuming, and sometimes cause deformation of the modified biomolecules.

Accordingly, the inventors of the present invention found that fixing the agent on a surface of an electrode provides excellent means for LPS detection and an excellent base for designing the electrochemical biosensor.

A well-studied Gram-negative organism (in metal binding) is Escherichia coli, which is because E. coli is a common laboratory strain and its characteristics are well known. In this organism, extrinsic metal ions mainly bind to a polar head group of an LPS located in an outer membrane (Beveridge and Koval, 1981; Strain et al., 1983).

Recently, a metal complex binding by an O-side chain-LPS of the Gram-negative bacteria was reported by Langley and Beveridge. This LPS layer may be extremely anionic. Accordingly, this LPS layer may extend over the outer membrane protein. Moreover, this LPS layer is thought to be a main part of the metal binding in the Gram-negative bacteria. Accordingly, the LPS is thought to play a decisive role in specific interaction of an anionic group in a carbohydrate moiety with a divalent ion such as Cd2+, Cu2+, Pb2+, and Zn2+(Langley and Beveridge, 1999).

Although such various methods are being used for LPS detection, the use of a metal complex and regeneration of an LPS sensor have not been disclosed in the previous art. In addition, an LPS sensor based on the metal complex is expected to have a higher degree of regeneration than a biosensor based on a natural receptor such as an antibody, enzyme, or peptide and to be easily fabricable.

### SUMMARY

The present invention is directed to a biosensor electrode for detecting lipopolysaccharides (LPSs).

Embodiments of the present invention provide an LPS sensor based on a metal complex which solves problems of the related art and meets needs of the industry.

Other embodiments of the present invention provide a biosensor for LPS detection using an NTA-Cu complex modified gold electrode and a manufacturing method for competitive electrochemical analysis. A gold electrode having a self-assembled monolayer (SAM) of 3-mercaptopropionic acid (MPA) is processed with nitrilotriacetic acid (NTA), and then chelated with the NTA using Cu ions. The LPS is coordinated with a free region with NTA-Cu complex. Performance of the biosensor for LPS detection of the present invention is evaluated by impedance spectroscopy.

Still other embodiments of the present invention provide high selectivity, high sensibility, and high degree of regeneration.

According to an aspect of the present invention, there is provided a method of forming a biosensor electrode for lipopolysaccharide (LPS) detection including providing a metal electrode, forming a metal electrode/3-mercaptopropionic acid (MPA) by depositing MPA on the metal electrode, forming a metal electrode/MPA/n-hydroxy-succinimide (NHS) by ester-bonding NHS and the MPA on the metal electrode/MPA, forming a metal electrode/MPA/nitrilotriacetic acid (NTA) by amide-bonding NTA-C₄—NH₂ and the MPA of the metal electrode/MPA/NHS, and forming a metal electrode/MPA/NTA/Cu by coordinate-bonding Cu²⁺ and the NTA of the metal electrode/MPA/NTA.

The NTA-C₄—NH₂ is a material in which four carbon atoms and an amine are attached to NTA. That is, the NTA-C₄—NH₂ is a compound n-(5-amino-1-carboxypentyl)iminodiacetic acid as shown in following formula.

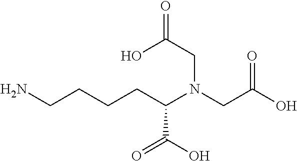 [SMILES: NCCCC[C@@H](C(=O)O)N(CC(=O)O)CC(=O)O]

The forming of the metal electrode/MPA includes immersing the metal electrode in a solution in which MPA is dissolved in an ethanol-water solvent.

The forming of the metal electrode/MPA/NHS includes immersing the metal electrode/MPA in a solution in which 1-ethyl-3-(3-dimethylaminopropyl) carbodiimide hydrochloride (EDC) and NHS are dissolved in a 2-(N-morpholino)ethanesulfonic acid (MES) solvent.

The reaction is as follows. The EDC reacts with a carboxyl group of the MPA and activates the MPA, which may be represented by the following reaction formula (1).

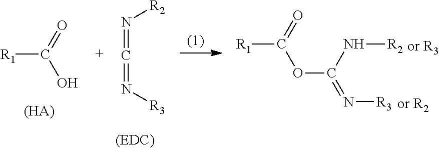

The activated ester compound reacts with NHS to be converted to an NHS ester, which may be represented by the following reaction formula (2).

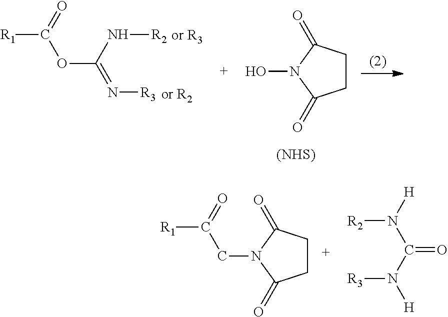

As a result, the NHS is coupled to Au/MPA, which corresponds to step (c) in FIG. 1.

The forming of the metal electrode/MPA/NTA includes immersing the metal electrode/MPA/NHS in a solution in which NTA-C₄—NH₂ is dissolved in an 2-(N-morpholino)ethanesulfonic acid (MES) solvent.

The reaction is as follows. The NHS ester compound forms an amide bonding with an amine of the NTA-C₄—NH₂, which may be represented by the following reaction formula (3).

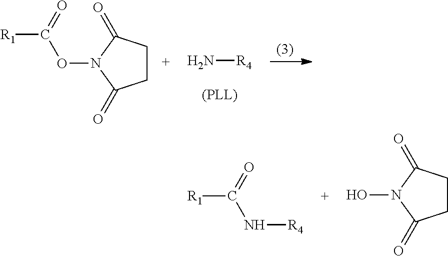

As a result, an Au/MPA/NTA electrode is obtained, which corresponds to step (d) in FIG. 1.

The forming of the metal electrode/MPA/NTA/Cu includes immersing the metal electrode/MPA/NTA in a NaAc/HAc solution containing CuCl₂, which corresponds to step (e) in FIG. 1.

In an exemplary embodiment of the present invention, the metal electrode may be gold (Au).

According to another aspect of the present invention, there is provided a biosensor electrode for LPS detection obtained by the above described method.

According to still another aspect of the present invention, there is provided a method of detecting an LPS using the biosensor electrode fabricated by the above described method. The method includes immersing the biosensor electrode in a culture medium containing an LPS to bond the LPS to copper ions of the biosensor electrode.

According to still another aspect of the present invention, there is provided a method of regenerating the biosensor electrode by which an LPS is detected including providing a metal electrode/MPA/NTA by immersing the biosensor electrode of a metal electrode/MPA/NTA/Cu/LPS in an ethylenediaminetetraacetic acid (EDTA) solution to remove Cu²⁺, and forming a metal electrode/MPA/NTA/Cu by immersing the metal electrode/MPA/NTA in an NaAc/HAc solution containing CuCl₂.

According to still another aspect of the present invention, there is provided a biosensor electrode for LPS detection including a metal electrode on which NTA-C₄—NH₂ coordinated with Cu²⁺ is coupled.

The coupling on the metal electrode includes deposition of 3-mercaptopropionic acid (MPA) on the metal electrode, and amide bonding of NTA-C₄—NH₂ on the MPA.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 provides a schematic view of an experimental method of forming an electrode of the present invention;

FIG. 2 shows Nyquist plots of different electrodes in a PBS solution (10 mM, pH 6.0) containing 2 mM Fe(CN)₆^{3-/4-};

FIG. 3A shows Nyquist plots of the NTA-C₄—NH₂—Cu sensor after incubation in an LPS/PBS solution;

FIG. 3B shows a linear relationship between log values of concentrations of LPS and ΔRₑₜ;

FIG. 4 shows Nyquist plots of the NTA-C₄—NH₂—Cu sensor after regeneration in the EDTA solution, wherein the solid line depicts a first sensing, the dotted line depicts a first regeneration, and the dashed line depicts a second regeneration;

FIG. 5 shows a selectivity of the NTA-C₄—NH₂—Cu sensor with respect to biological entities which are s5×10⁴ ngmL⁻¹ BSA/PBS, 100 ngmL⁻¹ DNA/PBS, 2.5×10⁴ ngmL⁻¹ RNA/PBS, 4×10³ ngmL⁻¹ glucose/PBS, and 1.0 ngmL⁻¹ LPS/PBS; and

FIG. 6 shows Nyquist plots of the NTA-C₄—NH₂—Cu sensor. Here, (a) represents the Au/MPA/NTA/Cu activated in the PBS solution, (b) represents the Au/MPA/NTA/Cu activated in the mixture of BSA, RNA, DNA, and glucose, and (c) represents the Au/MPA/NTA/Cu activated in the mixture of BSA, RNA, DNA, glucose, and LPS in PBS solution.

### DETAILED DESCRIPTION

Exemplary embodiments of the present invention will be described in detail below with reference to the accompanying drawings. While the present invention is shown and described in connection with exemplary embodiments thereof, it will be apparent to those skilled in the art that various reformations can be made without departing from the spirit and scope of the invention.

Materials and Apparatus

3-mercaptopropionic acid (MPA), 2-(N-morpholino)ethanesulfonic acid (MES), N-hydroxy-succinimide (NHS), 1-ethyl-3-(3-dimethylaminopropyl) carbodiimide hydrochloride (EDC), ethylenediaminetetraacetic acid (EDTA), N-(5-amino-1-carboxypentyl)iminodiacetic acid (NTA-C₄—NH₂), K₃Fe(CN)₆, K₄Fe(CN)₆, acetic acid (HAc), and sodium acetate (NaAc) were purchased from Sigma-aldrich and used without further purification.

Lipopolysaccharides (LPS) extracted from Escherichia coli 055:B5 (L4524) was purchased from Sigma-Aldrich, and stored at a temperature of −20° C. All solutions were fabricated from ultrapure water (resistivity: 18.2 MΩ/cm) through a Millipore MilliQ water purification system. All electrochemical experiments were performed using VSR Potentiostat (Princeton Applied Research, USA), and the resultant curves were recorded using a VSP EC-Lab software. A conventional three-electrode cell was used for performing electrochemical impedance spectroscopy (EIS). Ag/AgCl and a platinum (Pt) plate were respectively used as a reference electrode and an opposite electrode. In every modification and detection stage, an operating electrode was detected by EIS in 2 mM Fe(CN)6^{3-/4-}(1:1)/PBS solution. An amplitude-sine wave of about 10 mV was applied in a frequency range of 0.1 Hz to 100 kHz.

Preparation of Gold Electrode

A gold electrode with a diameter of 2.0 mm was prepared. The gold electrode was polished using 0.05 μm alumina (Al₂O₃) powder and thoroughly washed with distilled water. The gold electrode was subsequently ultrasonicated in ethanol and in water for 20 minutes each, and then washed with distilled water. The gold electrode was immersed in a piranha solution (30% H₂O₂/98% H₂SO₄ (1/3, v/v)) for 30 minutes, and then washed with distilled water. The polished gold electrode was subjected to cyclic voltammetry in a 1 M HClO₄ solution with a voltage range of 0 to 1.5 V at a scan rate of 100 mVs⁻¹ for 30 cycles and then washed with distilled water.

Formation of MPA Layer on Gold Electrode

The gold electrode was immersed in 20 mM MPA (in 3:1 v/v ethanol/water) overnight to form a self-assembled monolayer (SAM) of MPA on the gold electrode. The gold electrode with the SAM of MPA thereon was washed with water, after which the next step was carried out.

NHS Bonding on Au/MPA Electrode

The Au/MPA electrode was immersed in an EDC/NHS solution (pH=6.0) (in 10 mM MES) for 10 minutes in order for NHS to be coupled with the Au/MPA.

The reaction process is as follows. A carboxyl group of the MPA reacts with the EDC to be activated. The activated ester compound reacts with NHS to be converted to an NHS ester. As a result, the NHS is coupled with the Au/MPA.

The NHS coupled with the Au/MPA was washed with distilled water for use in the next step.

NTA-C₄—NH₂ Bonding on Au/MPA Electrode

The Au/MPA/NHS electrode acquired in the previous step was immersed in an NTA-C₄—NH₂ solution (pH=6.8) (in 5 mM MES) for 30 minutes to form an Au/MPA/NTA electrode.

The reaction process is as follows. An amine of NTA-C₄—NH₂ reacts with the NHS ester to form an amide bonding. As a result, the Au/MPA/NTA electrode was obtained.

The Au/MPA/NTA electrode was washed with distilled water for use in the next step.

Copper Ion Coordination with Au/MPA/NTA

The previously obtained Au/MPA/NTA electrode was immersed in a NaAc/HAc 0.1 mol/L solution (pH=5.0) containing 5 mM CuCl₂ with stiffing for 20 minutes to form Cu²⁺ coordinated NTA-C₄—NH₂. As a result, the Au/MPA/NTA electrode was modified to be an Au/MPA/NTA/Cu electrode.

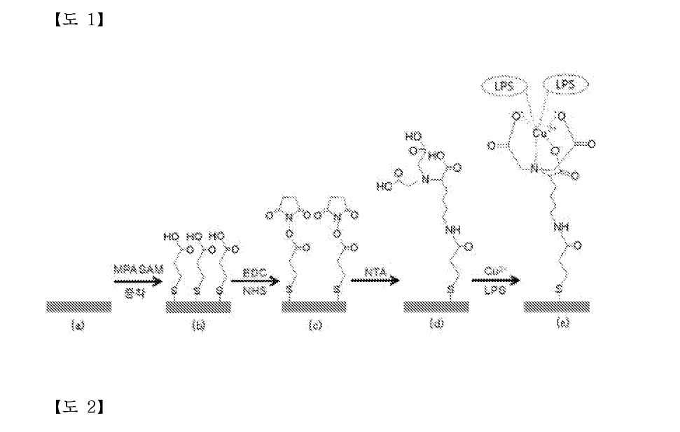

FIG. 1 provides a schematic view of an experimental method of forming the electrode.

Characteristics of the Au/MPA/NTA/Cu modified electrode were confirmed at each step using EIS (2 mM Fe(CN)₆^{3-/4-}/PBS (10 mM, pH=6.0)).

Sensor Regeneration

The fabricated NTA-Cu sensors were incubated in 10 mM PBS solutions (pH=6.0) containing different concentrations of an LPS for 30 minutes. An EIS response of the sensor was recorded in 2 mM Fe(CN)₆^{3-/4-}/PBS (10 mM, pH=6.0) after washing the sensor in the PBS solution. In order to confirm the regeneration of the sensor, the Au/MPA/NTA/Cu/LPS electrode was immersed in a 0.1 M EDTA solution for 30 minutes to remove Cu²⁺ from the electrode, and the processed Au/MPA/NTA electrode was once more immobilized with Cu²⁺ under the conditions described above. The Au/MPA/NTA/Cu sensor was incubated in the same LPS/PBS solution. The LPS-collected electrode was checked by EIS in the same solution.

Result

### Electrochemistry of NTA-C₄—NH₂—Cu Sensor

An electrical property of the NTA-C₄—NH₂—Cu electrode was measured at each step by the EIS response. EIS generally provides detailed information of changes in a surface during a modification process. A typical impedance spectrum (provided in the form of a Nyquist plot) provides a semicircle portion at higher frequencies corresponding to an electron-transfer-limited process, and a linear portion at lower frequencies corresponding to a diffusion-limited process. A diameter of the semicircle part in the impedance spectrum refers to an electron-transfer resistance (Rₑₜ.), which reflects an electron-transfer movement of a redox probe in a surface of the electrode. (Ding et al., 2007; Qiu et al., 2009; Baur et al., 2010).

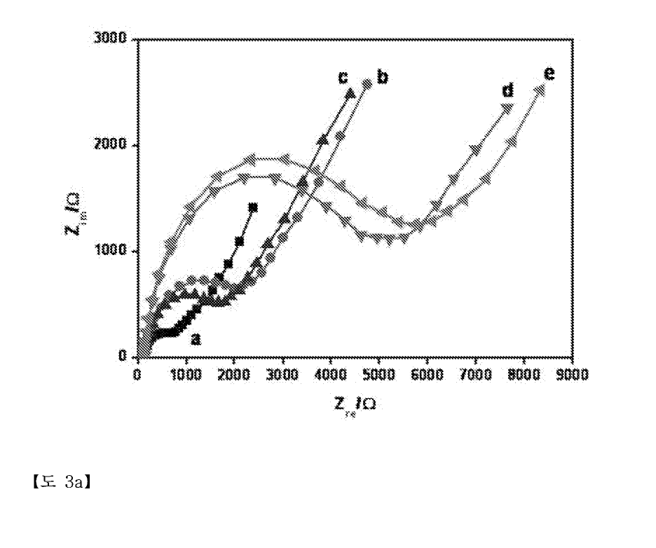

FIG. 2 shows Nyquist plots of different electrodes in a PBS solution (10 mM, pH 6.0) containing 2 mM Fe(CN)₆^{3-/4-}; (a) bare gold, (b) Au/MPA, (c) Au/MPA/NTA, (d) Au/MPA/NTA/Cu, and (e) Au/MPA/NTA/Cu/LPS. The range of frequencies is from 0.1 Hz to 100 KHz, and the disturbance amplitude is 10 mV.

Plot a in FIG. 2 shows that an almost straight Nyquist plot was made by the bare gold. After performing treatment with MPA, NTA-C₄—NH₂, and Cu²⁺, Rₑₜ increased (plots b to d in FIG. 2). In addition, the EIS shows that the surface treatment was successful and the electron-transfer movement was interrupted. In particular, a significant increase in interface resistance was observed after the LPS was detected by the NTA-C₄—NH₂—Cu electrode. It is thought that the increase in the interface resistance was because the LPS blocked both of electron-transfer and mass-transfer through a surface layer, and thereby insulated the electrode and interrupted an access of the redox probe to a surface of the electrode.

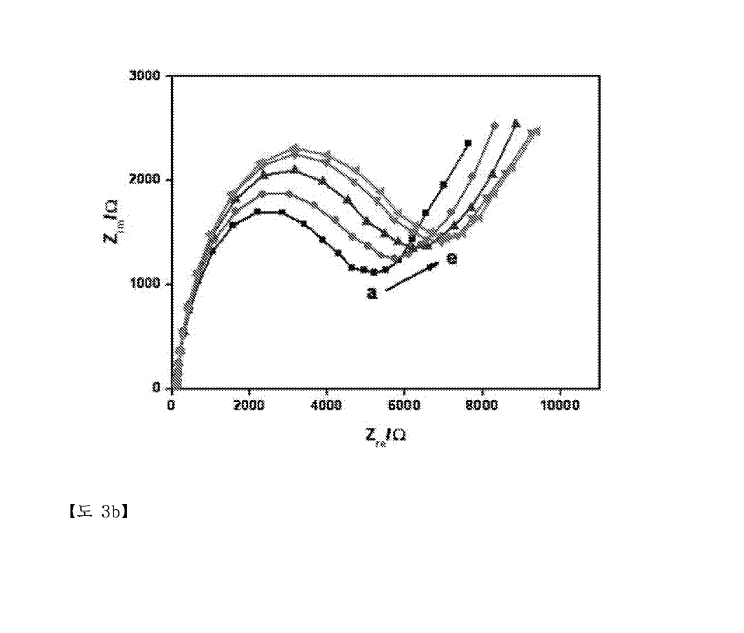

The NTA-C₄—NH₂—Cu sensor was incubated in a series of LPS/PBS solutions having a concentration range of 0.001 to 1.0 ngmL⁻¹. Next, the electrode was checked by EIS according to the LPS concentration. A difference of the electron-transfer resistance (ΔRₑₜ) between the NTA-C₄—NH₂—Cu electrode and the NTA-C₄—NH₂—Cu-LPS electrode was calculated according to a reference document (Ding et al., 2007). FIG. 3A shows Nyquist plots of the NTA-C₄—NH₂—Cu sensor after incubation in the LPS/PBS solution (b to e: 0.001, 0.01, 0.1, 1.0 ngmL⁻¹). FIG. 3B shows a linear relationship between log values of concentrations of LPS and ΔRet.

As illustrated in FIG. 3, the Rₑₜ is proportional to the concentration of LPS in the range of 0.001 to 1.0 ngmL⁻¹. In addition, the linear progression may be formularized as y=293.7×Log [ITS]+1363.3 (R2=0.9171).

### Regeneration and Stability of Sensor

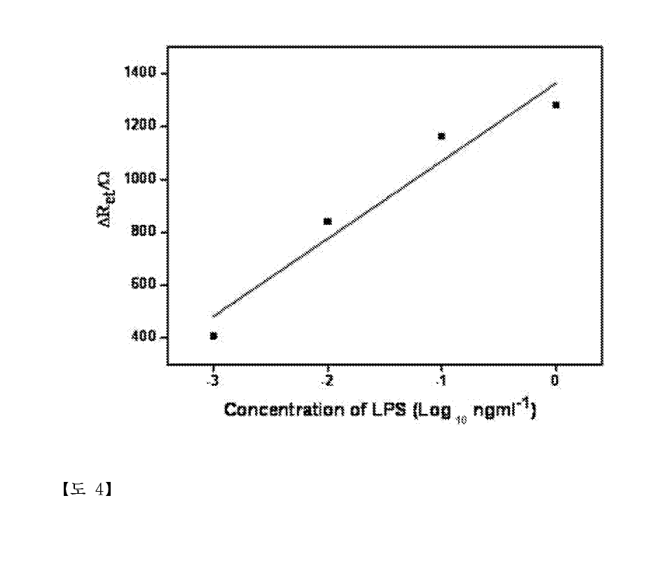

A regeneration property of the modified electrode was evaluated using the EDTA solution. The Au/MPA/NTA/Cu/LPS electrode was immersed in a 0.1 M EDTA solution for 30 minutes to remove Cu. The Au/MPA/NTA electrode obtained after washing in the PBS solution was reactivated in 2 mM Fe(CN)₆^{3-/4-} (1:1)/PBS solution, and then an EIS response was checked as shown in FIG. 4.

FIG. 4 shows Nyquist plots of the NTA-C₄—NH₂—Cu sensor after regeneration in the EDTA solution, wherein the solid line depicts a first sensing, the dotted line depicts a first regeneration, and the dashed line depicts a second regeneration, and wherein (a) represents Au/MPA/NTA, (b) represents Au/MPA/NTA/Cu, and (c) represents Au/MPA/NTA/Cu/LPS.

Next, the Au/MPA/NTA electrode was reprocessed with Cu²⁺ as described above, and rechecked by EIS. The result is as shown in FIG. 4. Finally, the immobilized Au/MPA/NTA/Cu electrode was reprocessed with 1.0 ngmL⁻¹ LPS, and checked again by EIS. The regeneration process was repeated three times before re-using the biosensor. The measurement shows that the regenerated sensor made a similar response to the initial sensor. The difference is only 4%. This result shows that the regeneration can be performed easily.

### Sensor Selectivity of the Present Invention

The sensor was activated in alkali cell lysates: 5×10⁴ ngmL⁻¹ bovine serum albumin (BSA)/PBS, 2.5×10⁴ ngmL⁻¹ RNA/PBS, and 100 ngmL⁻¹ DNA/PBS, to evaluate the selectivity of the NTA-C₄—NH₂—Cu sensor.

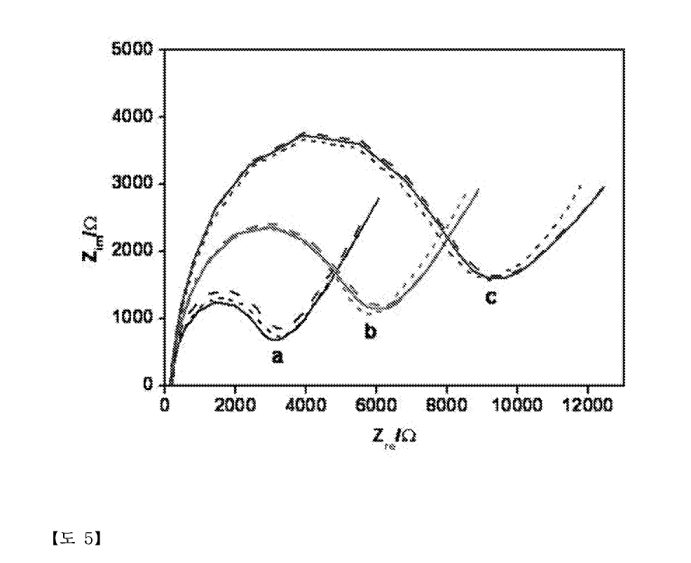

One of potential advantages of the sensor of the present invention is the selectivity with respect to target molecules. Immobilized or free metal ions are widely used for purification of protein, and selectively bind to nucleic acid molecules (Murphy et. al, 2003). Tan et al. reported priority of interactions between biomolecules and metal ions as follows; Cu²⁺, Ni²⁺, Zn²⁺, Co²⁺, and Fe³⁺: endotoxin>RNA>DNA (Tan et al., 2007). Accordingly, the selectivity of the NTA-C₄—NH₂—Cu sensor of the present invention was evaluated using available interfering biomolecules. First, the sensor was incubated in 5×10⁴ ngmL⁻¹ BSA/PBS, 100 ngmL⁻¹ DNA/PBS, 2.5×10⁴ ngmL⁻¹ RNA/PBS, 4×10³ ngmL⁻¹ glucose/PBS, and 1.0 ngmL⁻¹ LPS/PBS each for 30 minutes. EIS responses were recorded after washing the sensor with a PBS solution. Differences in Rₑₜ values were not observed among the BSA, the RNA, the DNA, and the glucose as shown in FIG. 5.

FIG. 5 shows the selectivity of the NTA-C₄—NH₂—Cu sensor with respect to biological entities which are s5×10⁴ ngmL⁻¹ BSA/PBS, 100 ngmL⁻¹ DNA/PBS, 2.5×10⁴ ngmL⁻¹ RNA/PBS, 4×10³ ngmL⁻¹ glucose/PBS, and 1.0 ngmL⁻¹ LPS/PBS. The NTA-C₄—NH₂—Cu probe shows a superior selectivity for an LPS (1 ngmL⁻¹ even in lower concentrations) than to other biomolecules. In addition, the sensor of the present invention does not respond the extant protein, that is, BSA. In the next step, the four solutions, that is, BSA, RNA, DNA, and glucose, were mixed together.

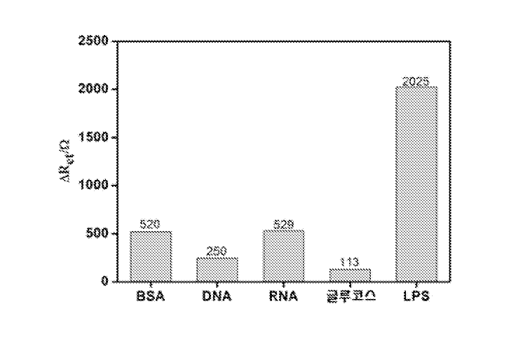

The sensing process of the present invention was performed under the same conditions in the mixture and in the 1.0 ngmL⁻¹ LPS/PBS. EIS responses were compared as shown in FIG. 6.

FIG. 6 shows Nyquist plots of the NTA-C₄—NH₂—Cu sensor. Here, (a) represents the Au/MPA/NTA/Cu activated in the PBS solution, (b) represents the

Au/MPA/NTA/Cu activated in the mixture of BSA, RNA, DNA, and glucose, and (c) represents the Au/MPA/NTA/Cu activated in the mixture of BSA, RNA, DNA, glucose, and an LPS in a PBS solution.

As shown in FIG. 6, a remarkable change of Rₑₜ value occurred in the LPS/PBS solution. That is, the sensor of the present invention has excellent selectivity even when interfering biomolecules exist.

It will be apparent to those skilled in the art that various reformations can be made to the above-described exemplary embodiments of the present invention without departing from the spirit or scope of the invention. Thus, it is intended that the present invention covers all such reformations provided they come within the scope of the appended claims and their equivalents.

What is claimed is:

1. A method of forming a biosensor electrode for lipopolysaccharide (LPS) detection, comprising:
providing a metal electrode;
forming a metal electrode/3-mercaptopropionic acid (MPA) by depositing MPA on the metal electrode;
forming a metal electrode/MPA/n-hydroxy-succinimide (NHS) by ester-bonding NHS and the MPA on the metal electrode/MPA;
forming a metal electrode/MPA/nitrilotriacetic acid (NTA) by amide-bonding NTA-C₄—NH₂ and the MPA of the metal electrode/MPA/NHS; and
forming a metal electrode/MPA/NTA/Cu by coordinate-bonding Cu²⁺ and the NTA of the metal electrode/MPA/NTA.

2. The method according to claim 1, wherein the forming of the metal electrode/MPA comprises immersing the metal electrode in a solution in which MPA is dissolved in an ethanol-water solvent.

3. The method according to claim 1 or 2, wherein the forming of the metal electrode/MPA/NHS comprises immersing the metal electrode/MPA in a solution in which 1-ethyl-3-(3-dimethylaminopropyl) carbodiimide hydrochloride (EDC) and NHS are dissolved in a 2-(N-morpholino)ethanesulfonic acid (MES) solvent.

4. The method according to claim 1 or 2, wherein the forming of the metal electrode/MPA/NTA comprises immersing the metal electrode/MPA/NHS in a solution in which NTA-C₄—NH₂ is dissolved in a 2-(N-morpholino)ethanesulfonic acid (MES) solvent.

5. The method according to claim 1 or 2, wherein the forming of the metal electrode/MPA/NTA/Cu comprises immersing the metal electrode/MPA/NTA in a NaAc/HAc solution containing CuCl₂.

6. The method according to claim 1 or 2, wherein the metal electrode is gold (Au).

7. A biosensor electrode for lipopolysaccharide (LPS) detection obtained by the method according to claim 1 or 2.

8. A method of detecting lipopolysaccharides (LPSs) using the biosensor electrode according to claim 7, comprising:
immersing the biosensor electrode in a culture medium containing LPS to bond the LPS to copper ions of the biosensor electrode.

9. A method of regenerating the biosensor electrode by which LPSs are detected by the method according to claim 8, comprising:
providing a metal electrode/MPA/NTA by immersing the biosensor electrode of a metal electrode/MPA/NTA/Cu/LPS in an ethylenediaminetetraacetic acid (EDTA) solution to remove Cu²⁺; and
forming a metal electrode/MPA/NTA/Cu by immersing the metal electrode/MPA/NTA in a NaAc/HAc solution containing CuCl₂.

10. A biosensor electrode for lipopolysaccharide (LPS) detection, comprising:
a metal electrode on which NTA-C₄—NH₂ coordinated with Cu²⁺ is coupled.

11. The biosensor electrode for LPS detection according to claim 10, wherein the coupling on the metal electrode comprises:
deposition of 3-mercaptopropionic acid (MPA) on the metal electrode; and
amide bonding of NTA-C₄—NH₂ on the MPA. 10

12. The biosensor electrode for LPS detection according to claim 10 or 11, wherein the metal electrode comprises Au.

13. A method of forming a biosensor electrode for lipopolysaccharide (LPS) detection, comprising:
providing a metal electrode;
forming a metal electrode/3-mercaptopropionic acid (MPA) by immersing the metal electrode in a solution in which MPA is dissolved in an ethanol-water solvent;
forming a metal electrode/MPA/n-hydroxy-succinimide (NHS) by immersing the metal electrode/MPA in a solution in which 1-ethyl-3-(3-dimethylaminopropyl)carbodiimide hydrochloride (EDC) and NHS are dissolved in a 2-(N-morpholino)ethanesulfonic acid (MES) solvent;
forming a metal electrode/MPA/nitrilotriacetic acid (NTA) by immersing the metal electrode/MPA/NHS in a solution in which NTA-C₄—NH₂ is dissolved in MES solvent; and
forming a metal electrode/MPA/NTA/Cu by immersing the metal electrode/MPA/NTA in a NaAc/HAc solution containing CuCl₂.
